(19) United States
(12) Patent Application Publication
(10) Pub. No.: US 2004/0168202 A1
(43) Pub. Date: Aug. 26, 2004

(54) Game-program distribution system

(76) Inventor: Kazuyuki Ebihara, Abiko-shi (JP)

Correspondence Address: Law Office of Louis Woo, 717 North Fayette Street, Alexandria, VA, 22314, US

(21) Appl. No.: 10/787,882

(22) Filed: Feb. 27, 2004

Related U.S. Application Data
(62) Division of application No. 09/938,576, filed on Aug. 27, 2001.

(30) Foreign Application Priority Data
Sep. 11, 2000 (JP) 2000-275491
Sep. 26, 2000 (JP) 2000-291784

(51) Int. Cl. H04N 7/173; G06F 19/00; G06F 17/00; A63F 13/00; H04N 7/16; A63F 9/24

(52) U.S. Cl. 725/133; 463/40; 463/42; 725/141; 725/153

(57) ABSTRACT

A game-program distribution system includes a broadcasting station for transmitting a signal containing first data representative of a television program and second data representative of a game program related to the television program. A receiver operates for receiving the signal transmitted from the broadcasting station, and demodulating the received signal into the first data representative of the television program and the second data representative of the game program. The second data representative of the game program are downloaded from the receiver into a game machine.

### BACKGROUND OF THE INVENTION

1. Field of the Invention

This invention relates to a game-program distribution system. In addition, this invention relates to a transmitting apparatus, a receiving apparatus, and a game machine. Furthermore, this invention relates to a digital television broadcasting system. Also, this invention relates to a portable data terminal device and an in-store terminal device.

2. Description of the Related Art

A typical portable game machine is designed for use with a cartridge containing a ROM and a RAM loaded with data representing a program of a game and data representing conditions of the progress of the play of the game. The game machine has a body into and from which a cartridge is inserted and ejected. In general, different games are provided by different cartridges respectively. Users buy cartridges at stores or by mail order. Accordingly, the distribution of game programs to typical portable game machines tends to be inconvenient.

### SUMMARY OF THE INVENTION

It is a first object of this invention to provide an improved game-program distribution system.

It is a second object of this invention to provide an improved transmitting apparatus.

It is a third object of this invention to provide an improved receiving apparatus.

It is a fourth object of this invention to provide an improved game machine.

It is a fifth object of this invention to provide an improved digital television broadcasting system.

It is a sixth object of this invention to provide an improved portable data terminal device.

It is a seventh object of this invention to provide an improved in-store terminal device.

A first aspect of this invention provides a game-program distribution system comprising a broadcasting station for transmitting a signal containing first data representative of a television program and second data representative of a game program related to the television program; a receiver for receiving the signal transmitted from the broadcasting station, and demodulating the received signal into the first data representative of the television program and the second data representative of the game program; a game machine; and means for downloading the second data representative of the game program from the receiver into the game machine.

A second aspect of this invention is based on the first aspect thereof, and provides a game-program distribution system wherein the television program comprises an animation television program, and the game program relates to one of (1) a character in the animation television program and (2) a scenario of the animation television program.

A third aspect of this invention is based on the first aspect thereof, and provides a game-program distribution system wherein the broadcasting station adds game-program rewriting information to the transmitted signal, and the receiver recovers the game-program rewriting information from the received signal, and the downloading means downloads the game-program rewriting information from the receiver into the game machine.

A fourth aspect of this invention is based on the first aspect thereof, and provides a game-program distribution system wherein the broadcasting station adds accounting information to the transmitted signal, and the receiver recovers the accounting information from the received signal, and further comprising means for controlling use of the downloaded game program by the game machine in response to the accounting information recovered by the receiver.

A fifth aspect of this invention is based on the first aspect thereof, and provides a game-program distribution system wherein the broadcasting station adds effective-term information to the transmitted signal, and the receiver recovers the effective-term information from the received signal, and further comprising means for permitting the game machine to use the downloaded game program in a term determined by the effective-term information.

A sixth aspect of this invention provides a transmitting apparatus in the broadcasting station of the first aspect thereof.

A seventh aspect of this invention provides a receiving apparatus comprising the receiver of the first aspect thereof.

An eighth aspect of this invention provides a game machine comprising the game machine of the first aspect thereof.

A ninth aspect of this invention provides a digital television broadcasting system comprising a broadcasting station for transmitting a signal containing (1) data pieces and (2) index information; a receiver for receiving the signal transmitted from the broadcasting station, and demodulating the received signal into the data pieces and the index information; first means provided in the receiver for selecting ones from the data pieces in response to the index information and personal information; and second means for indicating the data pieces selected by the first means.

A tenth aspect of this invention provides a digital television broadcasting system comprising a broadcasting station for transmitting a signal containing data and index information, the data representing an electronic program guide; a receiver for receiving the signal transmitted from the broadcasting station, and demodulating the received signal into the data and the index information; first means provided in the receiver for selecting television programs from the electronic program guide represented by the data in response to the index information and personal information; and second means for indicating the television programs selected by the first means.

An eleventh aspect of this invention provides a digital television broadcasting system comprising a broadcasting station for transmitting a signal containing data and index information, the data representing electronic advertising bills; a receiver for receiving the signal transmitted from the broadcasting station, and demodulating the received signal into the data and the index information; first means provided in the receiver for selecting at least one from the electronic advertising bills represented by the data in response to the index information and personal information; and second means for indicating the electronic advertising bill selected by the first means.

A twelfth aspect of this invention is based on the ninth aspect thereof, and provides a digital television broadcasting system wherein the index information comprises (1) fixed information independent of contents of the data pieces and (2) non-fixed information depending on the contents of the data pieces.

A thirteenth aspect of this invention is based on the ninth aspect thereof, and provides a digital television broadcasting system further comprising a portable data terminal device, third means for downloading the selected data pieces from the receiver into the portable data terminal device, and fourth means provided in the portable data terminal device for indicating the downloaded data pieces.

A fourteenth aspect of this invention is based on the thirteenth aspect thereof, and provides a digital television broadcasting system further comprising an in-store terminal device, and fifth means for transmitting the downloaded data pieces from the portable terminal device to the in-store terminal device.

A fifteenth aspect of this invention provides a transmitting apparatus in the broadcasting station of the ninth aspect thereof.

A sixteenth aspect of this invention provides a receiving apparatus comprising the receiver of the ninth aspect thereof.

A seventeenth aspect of this invention provides a digital television broadcasting system comprising a broadcasting station for transmitting a signal containing data pieces; a receiver for receiving the signal transmitted from the broadcasting station, and demodulating the received signal into the data pieces; first means provided in the receiver for selecting ones from the data pieces in response to key words; and second means for indicating the data pieces selected by the first means.

An eighteenth aspect of this invention provides a portable data terminal device comprising the portable data terminal device of the thirteenth aspect thereof.

A nineteenth aspect of this invention provides an in-store terminal device comprising the in-store terminal device of the fourteenth aspect thereof.

### BRIEF DESCRIPTION OF THE DRAWINGS

FIG. 1 is a diagram of a game-program distribution system according to a first embodiment of this invention.

FIG. 2 is a diagram of the format of a packet.

FIG. 3 is a diagram of the format of game-type information in FIG. 2.

FIG. 4 is a diagram of the format of accounting information in FIG. 2.

FIG. 5 is a diagram of the format of effective-term information in FIG. 2.

FIG. 6 is a diagram of a portable game machine, a cartridge, and a satellite broadcasting receiver in FIG. 1.

FIG. 7 is a block diagram of the portable game machine and the cartridge in FIG. 6.

FIG. 8 is a flowchart of a segment of a control program for a controller within the satellite broadcasting receiver in FIGS. 1 and 6.

FIG. 9 is a flowchart of a segment of a control program for a CPU within the portable game machine in FIG. 7.

FIG. 10 is a flowchart of a first example of a block in FIG. 9.

FIG. 11 is a flowchart of a second example of the block in FIG. 9.

FIG. 12 is a diagram of a portable game machine, a cartridge, and a register in a system according to a second embodiment of this invention.

FIG. 13 is a flowchart of a segment of a control program for a CPU in the portable game machine in FIG. 12.

FIG. 14 is a diagram of a digital television broadcasting system according to a third embodiment of this invention.

FIG. 15 is a diagram of the format of a packet.

FIG. 16 is a diagram of the format of fixed information in FIG. 15.

FIG. 17 is a diagram of a first example of the format of semi-fixed information in FIG. 15.

FIG. 18 is a diagram of a second example of the format of the semi-fixed information in FIG. 15.

FIG. 19 is a diagram of the format of variable information in FIG. 15.

FIG. 20 is a block diagram of a set top box, a television apparatus, and a remote control transmitter in the third embodiment of this invention.

FIG. 21 is a diagram of a memory, a reception buffer, and an output buffer in FIG. 20.

FIG. 22 is a flowchart of a segment of a control program for a CPU in the set top box in FIG. 20.

FIG. 23 is a plan view of a portable terminal device in FIG. 14.

FIG. 24 is a diagram of the set top box, the television apparatus, the portable terminal device, and a VTR in FIG. 14.

FIG. 25 is a flowchart of a segment of a control program for a CPU within a set top box in a fourth embodiment of this invention.

FIG. 26 is a flowchart of a block in FIG. 25.

FIG. 27 is a diagram of a television apparatus, a set top box, and a network in a system according to a sixth embodiment of this invention.

FIG. 28 is a diagram of a television apparatus, a set top box, a portable terminal device, and another terminal device in a system according to a seventh embodiment of this invention.

### DETAILED DESCRIPTION OF THE INVENTION

First Embodiment

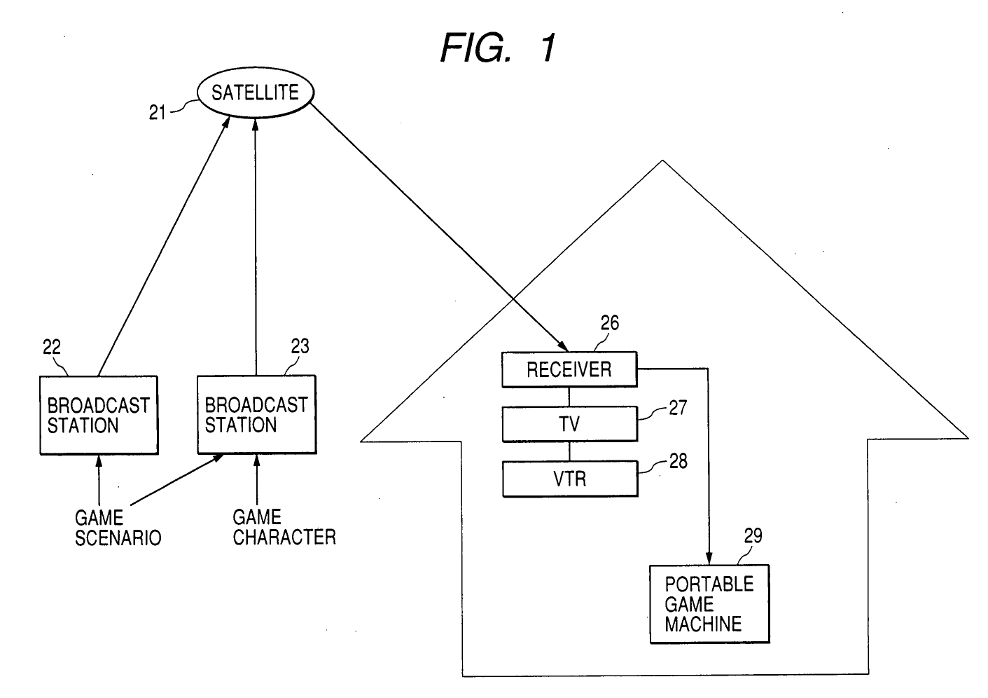

FIG. 1 shows a game-program distribution system according to a first embodiment of this invention. The system of FIG. 1 includes a broadcasting satellite 21, broadcasting stations 22 and 23, and satellite broadcasting receivers 26 (only one of which is shown in the drawing). In general, the satellite broadcasting receivers 26 are located at homes respectively.

The broadcasting station 22 is designed for data transmission. A game software maker provides the broadcasting station 22 with game-program data. The game-program data contain game-scenario data (that is, data representing a scenario of a game) and index information. Alternatively, the game-program data may contain game-program-bug correcting information (game-program-bug correcting data) and index information. At maker's request, the broadcasting station 22 transmits an uplink radio signal toward the broadcasting satellite 21 which contains the game-program data. The broadcasting satellite 21 receives the uplink radio signal. The broadcasting satellite 21 generates a downlink radio signal in response to the received uplink radio signal. The generated downlink radio signal contains the game-program data. The broadcasting satellite 21 transmits the downlink radio signal toward the satellite broadcasting receivers 26.

The broadcasting station 23 is designed for transmitting animation television programs. The game software maker provides the broadcasting station 23 with game-program data. The game-program data contain game-character data (that is, data representing a game character or characters usable in a game) and index information. Alternatively, the game-program data may contain game-scenario data (that is, data representing a scenario of a game) and index information. The game-program data may contain game-program-bug correcting information (game-program-bug correcting data) and index information. The broadcasting station 23 transmits an uplink radio signal toward the broadcasting satellite 21 which represents an animation television program, and which contains the game-program data. The game characters or the game scenario represented by the game-program data may be related to the animation television program. For example, the game characters represented by the game-program data may correspond to characters in the animation television program. The game scenario represented by the game-program data may be related to the scenario of the animation television program. The broadcasting satellite 21 receives the uplink radio signal. The broadcasting satellite 21 generates a downlink radio signal in response to the received uplink radio signal. The generated downlink radio signal represents the animation television program, and contains the game-program data. The broadcasting satellite 21 transmits the downlink radio signal toward the satellite broadcasting receivers 26. Accordingly, the animation television program and the game-program data are broadcasted together. As previously mentioned, the broadcasted game-program data may be related to the broadcasted animation television program.

With reference to FIG. 1, a satellite broadcasting receiver 26 is connected with a television apparatus 27 and a portable game machine 29. A VTR (video tape recorder) 28 is connected with the television apparatus 27. The device 26 receives a downlink radio signal from the broadcasting satellite 21. The satellite broadcasting receiver 26 converts the received downlink radio signal into a normal television signal representative of a television program. The satellite broadcasting receiver 26 outputs the television signal to the television apparatus 27 so that the television program represented by the television signal can be reproduced by the television apparatus 27. The television signal can be passed to the VTR 28 through the television apparatus 27. Thus, the television signal can be recorded by the VTR 28.

The satellite broadcasting receiver 26 includes a demodulator for converting the received downlink radio signal into game-program data (game-scenario data, game-character data, game-program-bug correcting information, and index information). The satellite broadcasting receiver 26 outputs the game-program data to the portable game machine 29. The game-program data can be downloaded into the portable game machine 29.

The broadcasting station 22 includes a formatting device or an encoding device for converting game-program data (game-scenario data, game-program-bug correcting information, and index information) into a stream of packets. The broadcasting station 22 further includes a modulator for converting the stream of packets into an uplink radio signal. Similarly, the broadcasting station 23 includes a formatting device or an encoding device for converting game-program data (game-character data, game-scenario data, game-program-bug correcting information, and index information) into a stream of packets. The broadcasting station 23 further includes a modulator for converting the stream of packets into an uplink radio signal.

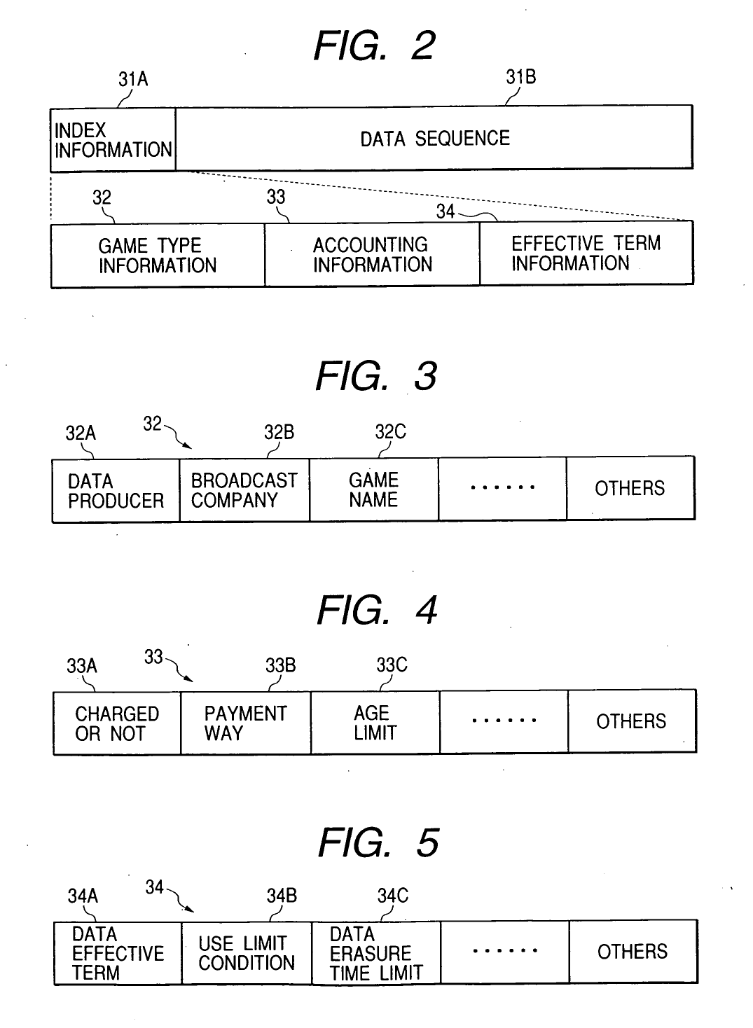

Each of uplink radio signals transmitted from the broadcasting stations 22 and 23 includes a stream of packets. As shown in FIG. 2, every packet has index information 31A and a data sequence 31B. In the packet, the index information 31A is followed by the data sequence 31B. The data sequence 31B represents a portion of contents such as a game scenario or a game character. Specifically, the data sequence 31B is a portion of game-scenario data, game-character data, or game-program-bug correcting information (game-program-bug correcting data). The data sequence 31B may represent a portion of a television program. The index information 31A relates to data in the sequence 31B. In more detail, the index information 31A relates to contents of game-program data (game-scenario data, game-character data, or game-program-bug correcting information) whose portion is in the data sequence 31B. The index information 31A and the data in the sequence 31B occupy different fields in the packet, respectively. As shown in FIG. 2, the index information 31A has a set of game-type information 32, accounting information 33, and effective-term information 34 which are arranged in that order.

As shown in FIG. 3, the game-type information 32 has a set of pieces including pieces 32A, 32B, and 32C. The information piece 32A indicates a producer of data in the sequence 31B (that is, a data producer or a game-program producer). The information piece 32B indicates a broadcasting company. The information piece 32C indicates the name of a game, that is, the title of the game.

As shown in FIG. 4, the accounting information 33 has a set of pieces including pieces 33A, 33B, and 33C. The information piece 33A indicates whether data in the sequence 31B (data to be downloaded) are charged for or free of charge. The information piece 33B indicates a way of payment which can be changed among different types including an advance payment type, a deferred payment type, and a partially-free partially-charged type. The information piece 33C indicates an age limit.

Some game characters and some game scenarios are charged for. A user is permitted to use a charged game character or a charged game scenario when paying a game-character producer or a game-scenario producer therefor. The accounting information 33 is designed for control toward settlement of accounts between users and producers. The accounting information 33 enables producers to collect fees from users.

As shown in FIG. 5, the effective-term information 34 has a set of pieces including pieces 34A, 34B, and 34C. The information piece 34A indicates an effective term for data in the sequence 31B. The information piece 34B indicates a use limit condition such as an age limit. The information piece 34C indicates a time limit for erasing data (downloaded data).

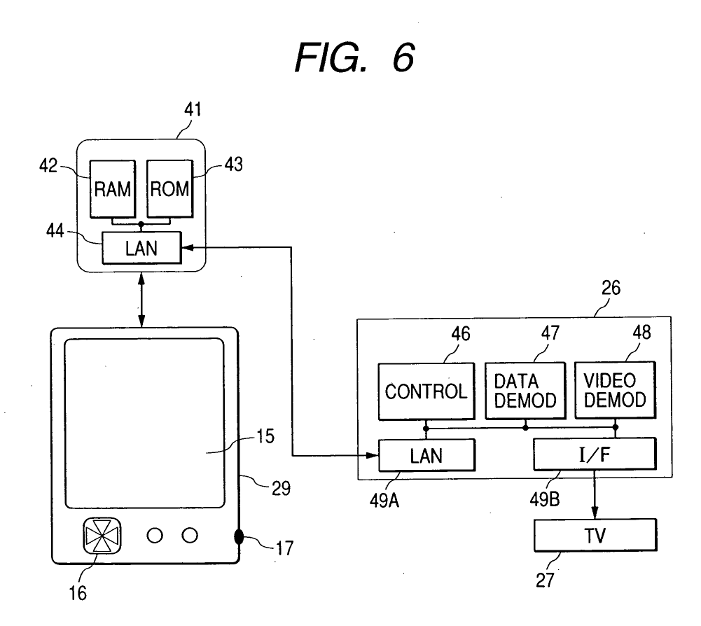

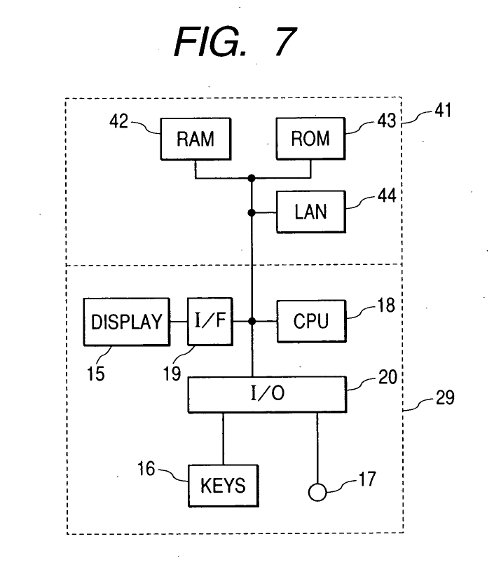

With reference to FIG. 6, the portable game machine 29 has a body into and from which a cartridge 41 can be inserted and ejected. The portable game machine 29 has a terminal (not shown) for connection with the cartridge 41. The terminal in the portable game machine 29 is connected with circuits contained therein. The cartridge 41 has a terminal (not shown) for connection with the portable game machine 29. The terminal in the cartridge 41 is connected with circuits contained therein. When the cartridge 41 is inserted into the portable game machine 29, the terminal in the cartridge 41 and the terminal in the portable game machine 29 are connected with each other. When the cartridge 41 is ejected from the portable game machine 29, the terminal in the cartridge 41 and the terminal in the portable game machine 29 are disconnected from each other. In the case where the terminal in the cartridge 41 and the terminal in the portable game machine 29 are connected with each other, the cartridge 41 and the portable game machine 29 can communicate with each other. Normally, the portable game machine 29 and the cartridge 41 are connected together.

As shown in FIGS. 6 and 7, the portable game machine 29 further has a liquid crystal display 15, operation keys 16, a communication port 17, a CPU 18, a display interface 19, and an input/output port 20. The liquid crystal display 15 is connected with the display interface 19. The operation keys 16 and the communication port 17 are connected with the input/output port 20. The CPU 18, the display interface 19, and the input/output port 20 are connected by a bus.

As shown in FIGS. 6 and 7, the cartridge 41 includes a RAM 42, a ROM 43, and a wireless LAN interface 44. The RAM 42, the ROM 43, and the wireless LAN interface 44 are connected by a bus. The ROM 43 and the RAM 42 are used to store data representing a program of a game and data representing conditions of the progress of the play of the game. When the cartridge 41 is inserted into the portable game machine 29, the bus in the cartridge 41 is connected to the bus in the portable game machine 29. Normally, the buses in the portable game machine 29 and the cartridge 41 are connected together.

The CPU 18 in the portable game machine 29 operates in accordance with a control program stored in an internal ROM or the ROM 43 within the cartridge 41. According to the control program, the CPU 18 controls the RAM 42, the ROM 43, the wireless LAN interface 44, the display interface 19, and the input/output port 20 to implement steps of operation which will be mentioned later. Specifically, the CPU 18 accesses the RAM 42 and the ROM 43, and a user can play the game whose program data are stored in the RAM 42 and the ROM 43.

The satellite broadcasting receiver 26 includes a combination of a controller 46, a data demodulator 47, a video demodulator 48, a wireless LAN interface 49A, and a communication interface 49B. The wireless LAN interface 49A in the satellite broadcasting receiver 26 and the wireless LAN interface 44 in the cartridge 41 can communicate with each other by wireless. Accordingly, the portable game machine 29 and the satellite broadcasting receiver 26 can communicate with each other via the wireless LAN interfaces 44 and 49A provided that the cartridge 41 is inserted into and connected with the portable game machine 29. In the satellite broadcasting receiver 26, the video demodulator 48 recovers video data (data representing a television program) from a received downlink radio signal. The video data are transmitted from the video demodulator 48 to the television apparatus 27 via the communication interface 49B so that the video data can be indicated on a display of the television apparatus 27. In the satellite broadcasting receiver 26, the data demodulator 47 recovers game-program data (game-scenario data, game-program-bug correcting information, game-character data, and index information) from the received downlink radio signal. The game-program data can be fed from the data demodulator 47 to the wireless LAN interface 49A before being transmitted to the wireless LAN interface 44 in the cartridge 41. The game-program data can be transmitted from the data demodulator 47 to the television apparatus 27 via the communication interface 49B. In this case, video contents of the game-program data can be indicated on the display of the television apparatus 27.

The communication port 17 in the portable game machine 29 is connected with circuits contained therein. The communication port 17 can be connected with the communication interface 49B in the satellite broadcasting receiver 26 by a wire. When the communication port 17 is connected with the communication interface 49B, the portable game machine 29 and the satellite broadcasting receiver 26 can communicate with each other.

The CPU 18 in the portable game machine 29 accesses the RAM 42 and the ROM 43 in the cartridge 41, and detects the type of a game program stored in the RAM 42 and the ROM 43 (that is, a game program represented by data in the RAM 42 and the ROM 43). The CPU 18 controls the wireless LAN interface 44 in the cartridge 41 to communicate with the wireless LAN interface 49A in the satellite broadcasting receiver 26. During the communication, the CPU 18 informs the satellite broadcasting receiver 26 of the type of the game program stored in the cartridge 41. In addition, the CPU 18 inquires the satellite broadcasting receiver 26 whether the type of a game program represented by currently received data is equal to or different from the type of the game program stored in the cartridge 41. Furthermore, the CPU 18 inquires the satellite broadcasting receiver 26 whether or not the currently received data are permitted to be downloaded. When the satellite broadcasting receiver 26 answers that the type of the game program represented by the currently received data is different from the type of the game program stored in the cartridge 41, the CPU 18 does not take further action on the currently received data. In the case where effective-term information 34 within index information 31 in the currently received data designates data saving for a specified term, the currently received data are saved to wait for the replacement of the game program in the cartridge 41 by a new one. When the specified term expires, the saved data are discarded. In the case where the satellite broadcasting receiver 26 answers that the currently received data are permitted to be downloaded, the CPU 18 requests the satellite broadcasting receiver 26 to send the currently received data. Then, the wireless LAN interface 44 gets the currently received data from the satellite broadcasting receiver 26. The CPU 18 controls the wireless LAN interface 44 and the RAM 42, thereby storing the currently received data into the RAM 42. Therefore, data representative of a game program permitted to be downloaded are transferred to the RAM 42. In other words, the data representative of the game program are downloaded into the cartridge 41. The portable game machine 29 can access the downloaded game program in the cartridge 41. Accordingly, the downloaded game program can be played by means of the portable game machine 29.

The ROM 43 in the cartridge 41 may be replaced by an erasable memory such as an EEPROM. In this case, the data representative of the game program may be downloaded into the erasable memory.

It should be noted that the wireless LAN interface 44 may be provided in the portable game machine 29 rather than the cartridge 41.

A downlink radio signal received by the satellite broadcasting receiver 26 contains game-program data and a signal representative of a television program. The satellite broadcasting receiver 26 demodulates the downlink radio signal into the game-program data and the television-program signal. The game-program data can be sent from the satellite broadcasting receiver 26 to the cartridge 41 while the television-program signal is transmitted from the satellite broadcasting receiver 26 to the television apparatus 27. The game-program data can be downloaded into the cartridge 41 while the television-program signal is indicated on the display of the television apparatus 27. Thus, a new game scenario and a new game character or characters can be added to the cartridge 41 during the broadcasting of a television program watched via the television apparatus 27. Accordingly, a user can play a new game by means of the portable game machine 29 after the end of the broadcasting of the television program. As understood from the previous description, to download game-program data into the cartridge 41, the user is required to watch a related television program.

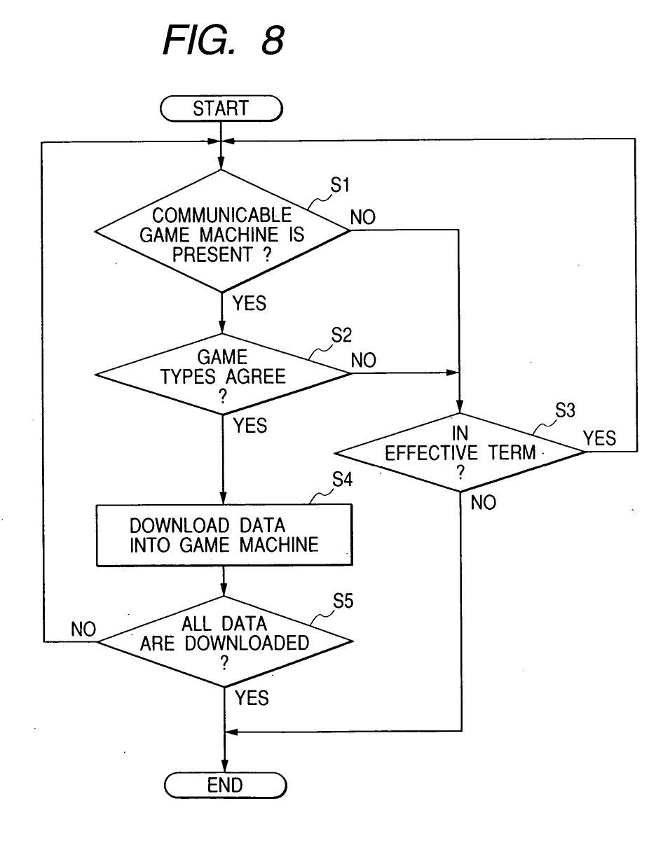

The controller 46 in the satellite broadcasting receiver 26 includes a CPU or a similar device which operates in accordance with a control program stored in an internal ROM. According to the control program, the device 46 controls the data demodulator 47, the video demodulator 48, the wireless LAN interface 49A, and the communication interface 49B. FIG. 8 is a flowchart of a segment of the control program for the controller 46. The control-program segment in FIG. 8 is started when game-program data are received.

As shown in FIG. 8, a first step S1 of the control-program segment decides whether a portable game machine 29 (a cartridge 41) is present in or absent from a communication service area with respect to the wireless LAN interface 49A. When a portable game machine 29 (a cartridge 41) is present in the communication service area, the control program advances from the step S1 to a step S2. On the other hand, when a portable game machine 29 (a cartridge 41) is absent from the communication service area, the. control program advances from the step S1 to a step S3.

The step S2 communicates with the portable game machine 29 (the cartridge 41) via the wireless LAN interface 49A, and gets information from the portable game machine 29 (the cartridge 41) which represents the type of a game program stored in the cartridge 41. The step S2 derives game-type information 32 from index information 31A in the received game-program data. By referring to the game-type information 32, the step S2 detects the type of a game program represented by the received game-program data. The step S2 decides whether the type of the game program represented by the received game-program data is equal to or different from the type of the game program stored in the cartridge 41. When the type of the game program represented by the received game-program data is equal to the type of the game program stored in the cartridge 41, the control program advances from the step S2 to a step S4. Otherwise, the control program advances from the step S2 to the step S3.

The step S4 controls the wireless LAN interface 49A to transmit the game-program data to the portable game machine 29 (the cartridge 41). As a result, the game-program data are downloaded into the cartridge 41.

A step S5 following the step S4 decides whether or not all the game-program data have been downloaded. When all the game-program data have been downloaded, the control program exits from the step S5 and then the current execution cycle of the control-program segment ends. Otherwise, the control program returns from the step S5 to the step S1.

The step S3 derives effective-term information 34 from the index information 31A in the received game-program data. By referring to the effective-term information 34, the step S3 detects an effective term for the received game-program data. The step S3 decides whether or not the present time is in the effective term. When the present time is in the effective term, the control program returns from the step S3 to the step S1. Thus, in this case, the satellite broadcasting receiver 26 waits for a portable game machine 29 (a cartridge 41) to enter the communication service area with respect to the wireless LAN interface 49A. On the other hand, when the present time is not in the effective term, the control program exits from the step S3 and then the current execution cycle of the control-program segment ends.

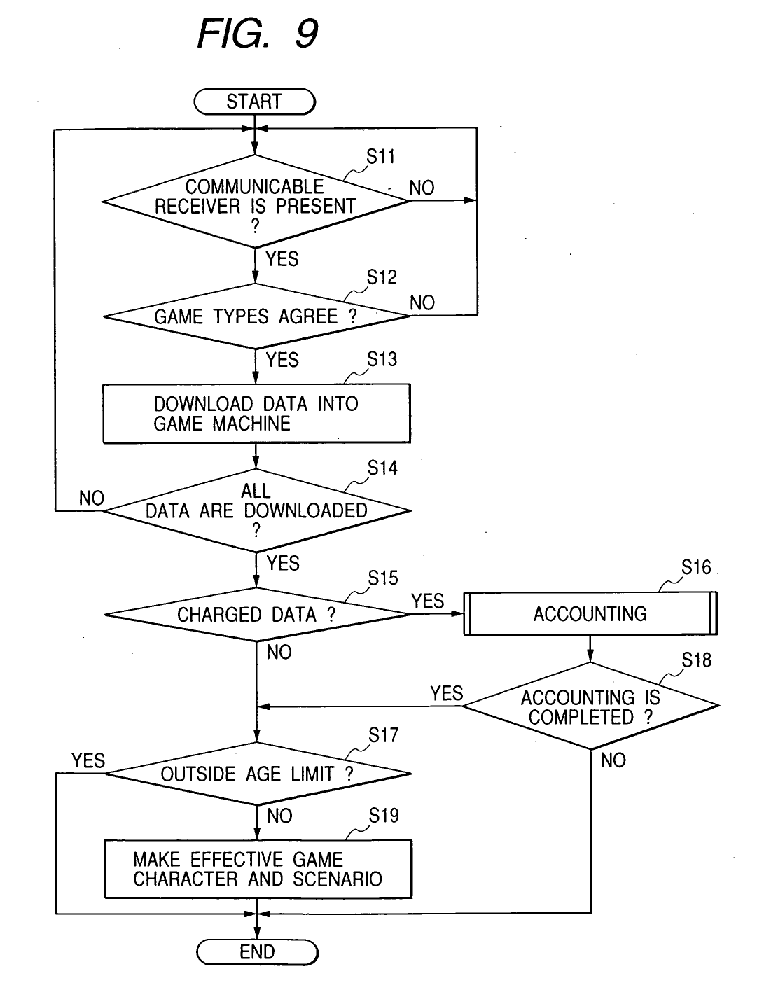

As previously mentioned, the CPU 18 in the portable game machine 29 operates in accordance with a control program stored in an internal ROM or the ROM 43 in the cartridge 41. FIG. 9 is a flowchart of a segment of the control program for the CPU 18. The control-program segment in FIG. 9 is repetitively executed.

As shown in FIG. 9, a first step S11 of the control-program segment decides whether a satellite broadcasting receiver 26 is present in or absent from a communication service area with respect to the wireless LAN interface 44. When a satellite broadcasting receiver 26 is present in the communication service area, the control program advances from the step S11 to a step S12. Otherwise, the step 11 is repeated.

A first example of the step S12 is as follows. The step S12 gets information from the satellite broadcasting receiver 26 which represents whether the type of a game program represented by received game-program data is equal to or different from the type of a game program stored in the cartridge 41. The step S12 detects the contents of the information. When the type of the game program represented by the received game-program data is equal to the type of the game program stored in the cartridge 41, the control program advances from the step S12 to a step S13. Otherwise, the control program returns from the step S12 to the step S11.

A second example of the step S12 is as follows. The step S12 accesses the RAM 42 and the ROM 44 in the cartridge 41, and thereby detects the type of a game program stored in the cartridge 41. The step S12 communicates with the satellite broadcasting receiver 26 by wireless, and gets information from the satellite broadcasting receiver 26 which represents the type of a game program represented by received game-program data. The step S12 decides whether the type of the game program represented by the received game-program data is equal to or different from the type of the game program stored in the cartridge 41. When the type of the game program represented by the received game-program data is equal to the type of the game program stored in the cartridge 41, the control program advances from the step S12 to the step S13. Otherwise, the control program returns from the step S12 to the step S11.

The step S13 receives the game-program data from the satellite broadcasting receiver 26 by wireless. The step S13 stores the received game-program data into the RAM 42 within the cartridge 41. Thus, the game-program data are downloaded into the cartridge 41.

A step S14 following the step S13 decides whether or not all the game-program data have been downloaded. When all the game-program data have been downloaded, the control program advances from the step S14 to a step S15. Otherwise, the control program returns from the step S14 to the step S11.

The step S15 derives accounting information 33 from index information 31A in the downloaded game-program data. By referring to the accounting information 34, the step S15 detects whether the downloaded game-program data are charged for or free of charge. When the downloaded game-program data are charged for, the control program advances from the step S15 to an accounting block S16. On the other hand, when the downloaded game-program data are free of charge, the control program advances from the step S15 to a step S17.

The step S17 detects an age limit represented by the accounting information 33. The step S17 retrieves information of user's age which is previously registered in the cartridge 41. The step S17 decides whether or not the user's age is within the age limit. When the user's age is within the age limit, the control program advances from the step S17 to a step S19. Otherwise, the control program exits from the step S17 and then the current execution cycle of the control-program segment ends.

The step S19 makes effective a game scenario and a game character or characters represented by the downloaded game-program data. Thus, the game scenario and the game character or characters can be used. After the step S19, the current execution cycle of the control-program segment ends.

A step S18 follows the accounting block S16. The step S18 decides whether or not accounting has been completed. When accounting has been completed, the control program advances from the step S18 to the step S17. Otherwise, the control program exits from the step S18 and then the current execution cycle of the control-program segment ends.

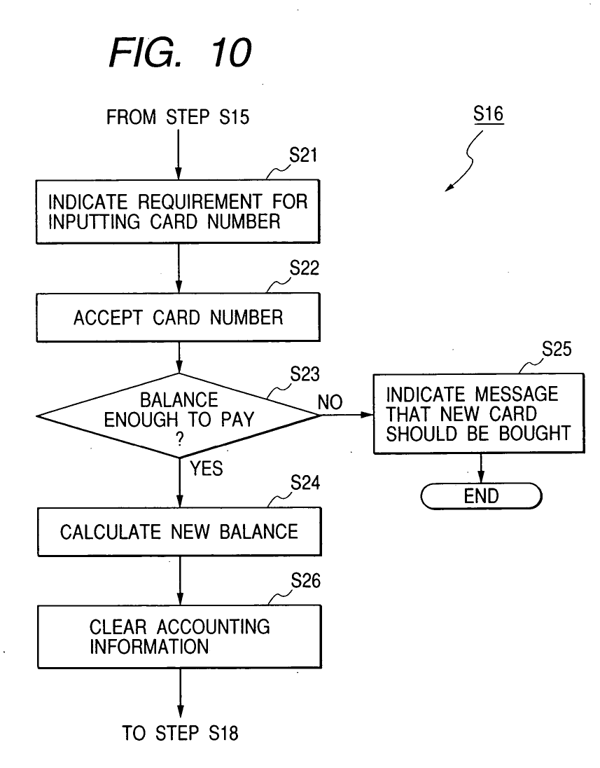

FIG. 10 shows an example of the accounting block S16 which premises that the user buys a prepaid card from a game-program producer in advance. As shown in FIG. 10, the accounting block S16 includes steps S21, S22, S23, S24, S25, and S26. The step S21 follows the step S15 in FIG. 9. The step S21 controls the display 15 of the portable game machine 29 to indicate a message for requiring the user to input a number assigned to a prepaid card owned by the user. In response to the message, the user actuates the operation keys 16 of the portable game machine 29 to input the card number.

The step S22 follows the step S21. The step S22 accepts information representing the inputted card number.

The step S23 follows the step S22. The step S23 identifies the prepaid card in accordance with the inputted card number. The step S23 decides whether or not the identified prepaid card has a balance enough to pay a fee. When the prepaid card has a balance enough to pay the fee, the control program advances from the step S23 to the step S24. Otherwise, the control program advances from the step S23 to the step S25.

The step S24 virtually pays the fee, and updates the balance in the prepaid card. The step S24 controls the display 15 of the portable game machine 29 to indicate the updating-resultant balance. The step S24 saves information representative of the updating-resultant balance in connection with the card number.

The step S26 follows the step S24. The step S26 clears the accounting information 33. After the step S26, the control program advances to the step S18 in FIG. 9.

The step S25 controls the display 15 of the portable game machine 29 to indicate a message for advising the user to buy a new prepaid card. After the step S25, the current execution cycle of the control-program segment ends.

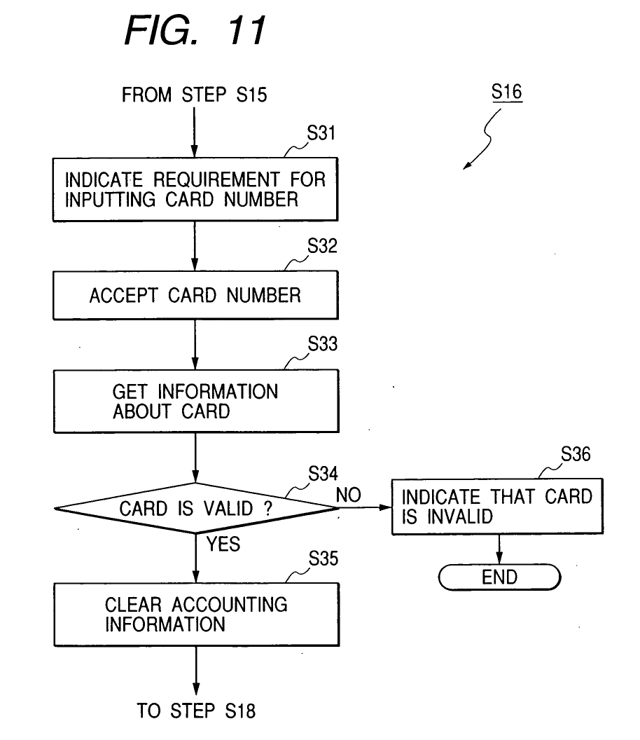

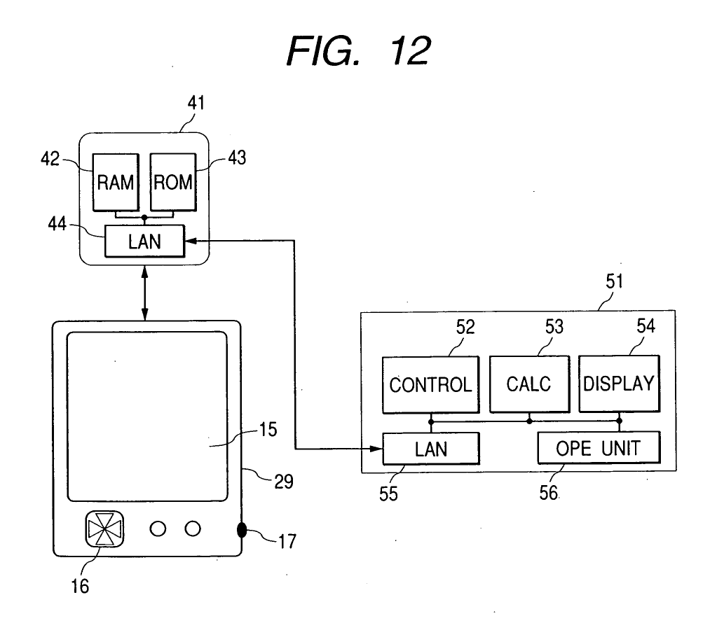

The communication port 17 of the portable game machine 29 can be connected with a communication network. In the case where the communication port 17 is connected with a communication network, the accounting block S16 in FIG. 10 may be replaced by that in FIG. 11.

The accounting block S16 in FIG. 11 includes steps S31, S32, S33, S34, S35, and S36. The step S31 follows the step S15 in FIG. 9. The step S31 controls the display 15 of the portable game machine 29 to indicate a message for requiring the user to input a number assigned to a credit card owned by the user. In response to the message, the user actuates the operation keys 16 of the portable game machine 29 to input the card number.

The step S32 follows the step S31. The step S32 accepts information representing the inputted card number.

The step S33 follows the step S32. The step S33 communicates with a credit card company via the communication network, and notifies the credit card company of the inputted card number. The step S33 receives, from the credit card company, information about the credit card identified by the inputted card number.

The step S34 follows the step S33. By referring to the received credit-card information, the step S34 decides whether the credit card is valid or invalid. When the credit card is valid, the control program advances from the step S34 to the step S35. On the other hand, the credit card is invalid, the control program advances from the step S34 to the step S36.

The step S35 clears the accounting information 33. After the step S35, the control program advances to the step S18 in FIG. 9.

The step S36 controls the display 15 of the portable game machine 29 to indicate a message that the credit card is invalid. After the step S36, the current execution cycle of the control-program segment ends.

It should be noted that the game-program distribution system of FIG. 1 may use terrestrial broadcasting instead of satellite broadcasting. Also, the game-program distribution system of FIG. 1 may use a combination of satellite broadcasting and cable television.

In every packet, index information 31A may be placed in a data sequence 31B. Index information 31A may be used for various types of control. According to a first example, a game scenario corresponding to a version of a game program to be downloaded is changed by use of game-type information 32 in index information 31A. According to a second example, a broadcasting company is identified by referring to game-type information 32, and game characters are transmitted on a zone-by-zone basis. According to a third example, control data synchronous with a television program are broadcasted by use of effective-term information 34 in index information 31A, and a downloaded game program is inhibited by the control data from being played until the end of the broadcasting of the television program. According to a fourth example, control data synchronous with a television program are broadcasted by use of effective-term information 34 in index information 31A, and a downloaded game program is permitted by the control data to be played for only a prescribed term from the end of the broadcasting of the television program.

A transmitted game scenario and transmitted game characters may be changed in accordance with contents of a television program (for example, a moving-picture television program or an animation television program) broadcasted therewith. Basically, it is unnecessary for users to bear the costs of transmission of game scenarios and game characters.

It should be noted that the cartridge 41 and the satellite broadcasting receiver 26 may be connected via a communication wire. In other words, the connection between the cartridge 41 and the receiver 26 may be on a wired basis rather than the wireless basis. In this case, the wireless LAN interface 44 in the cartridge 41 and the wireless LAN interface 49A in the receiver 26 are replaced by wire communication interfaces.

Second Embodiment

A second embodiment of this invention is similar to the first embodiment thereof except for design changes mentioned later. According to the second embodiment of this invention, accounts are settled as follows.

With reference to FIG. 12, after game-program data have been downloaded into a cartridge 41, a user carries the combination of a portable game machine 29 and the cartridge 41 to a store having a register 51. The register 51 includes a combination of a controller 52, a calculator 53, a display 54, a wireless LAN interface 55, and an operation unit 56. The controller 52 includes a CPU or a similar device which operates in accordance with a control program stored in an internal ROM. According to the control program, the device 52 controls the calculator 53, the display 54, the wireless LAN interface 55, and the operation unit 56. The wireless LAN interface 55 can communicate with a wireless LAN interface 44 in the cartridge 41 by wireless. Specifically, the controller 52 communicates with the cartridge 41 via the wireless LAN interface 55, and accesses downloaded game-program data in the cartridge 41. The controller 52 gets accounting information 33 from the game-program data. The controller 52 transfers the accounting information 33 to the calculator 53. The device 52 controls the calculator 53 to compute a fee on the basis of the accounting information 33. The device 52 controls the calculator 53 to inform the display 54 of the calculated fee. The device 52 controls the display 54 to indicate the calculated fee.

When the user pays the fee in the store, a store person actuates the operation unit 56 to input an account settlement signal. The controller 52 receives the account settlement signal from the operation unit 56. The controller 52 generates a command signal in response to the account settlement signal. The device 52 controls the wireless LAN interface 55 to transmit the command signal to the cartridge 41.

The cartridge 41 receives the command signal. The combination of the portable game machine 29 and the cartridge 41 operates in response to the received command signal. Specifically, a CPU 18 in the portable game machine 29 clears the accounting information 33 from the cartridge 41 in response to the command signal.

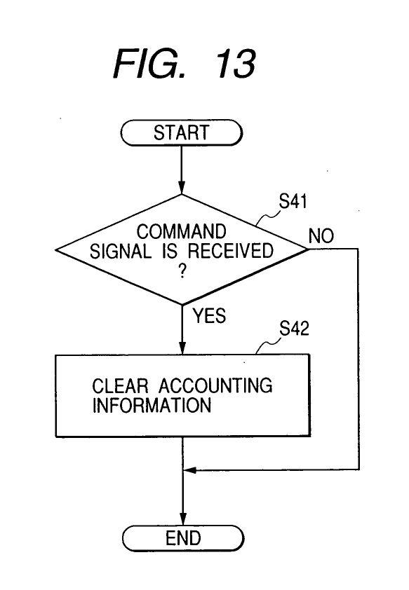

FIG. 13 is a flowchart of a segment of a control program for the CPU 18 in the portable game machine 29. The control-program segment in FIG. 13 is repetitively executed. As shown in FIG. 13, a first step S41 of the control-program segment decides whether or not a command signal is received from a register 51. When the command signal is received from the register 51, the control program advances from the step S41 to a step S42. Otherwise, the control program exits from the step S41, and then the current execution cycle of the control-program segment ends.

The step S42 clears the accounting information 33 in the cartridge 41. After the step S42, the current execution cycle of the control-program segment ends.

It should be noted that the cartridge 41 and the register 51 may be connected via a communication wire. In other words, the connection between the cartridge 41 and the register 51 may be on a wired basis rather than the wireless basis. In this case, the wireless LAN interface 44 in the cartridge 41 and the wireless LAN interface 55 in the register 51 are replaced by wire communication interfaces.

Third Embodiment

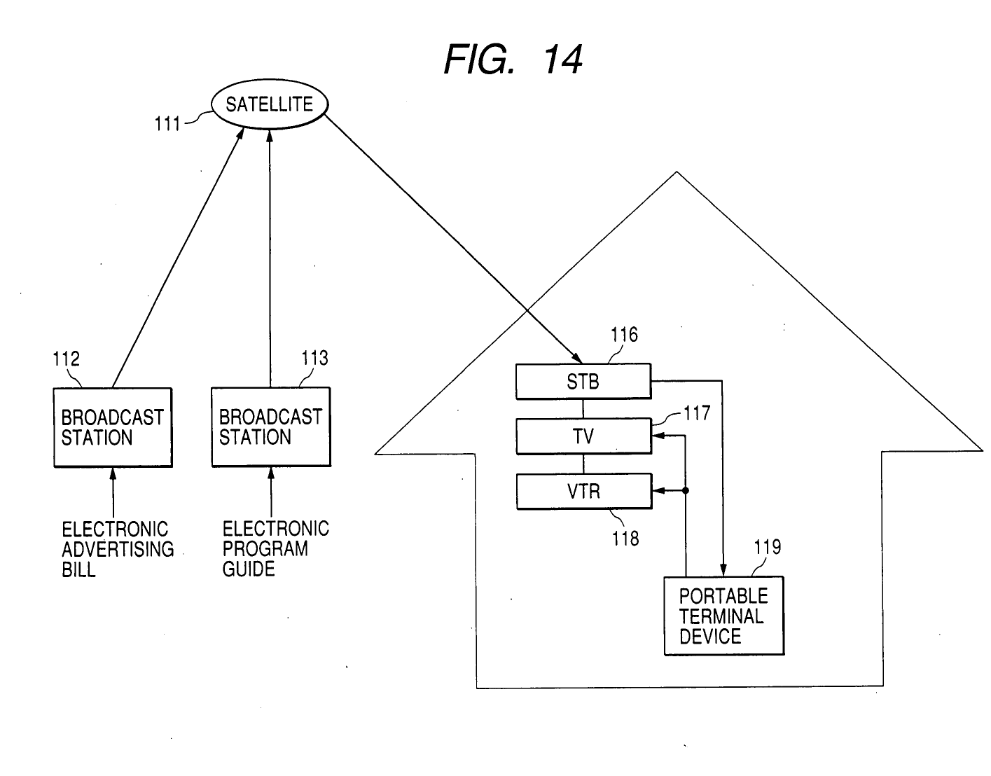

FIG. 14 shows a digital television broadcasting system according to a third embodiment of this invention. The system of FIG. 14 includes a broadcasting satellite 111, broadcasting stations 112 and 113, and set top boxes 116 (only one of which is shown in the drawing). The set top boxes 116 are abbreviated to the STB's 116. The STB's 116 include satellite broadcasting receivers, respectively. In general, the STB's 116 are located at homes respectively.

The broadcasting station 112 is designed for data transmission. Data transmitted by the broadcasting station 112 represent electronic advertising bills containing electronic coupons. The broadcasting station 112 transmits an uplink radio signal toward the broadcasting satellite 111 which contains the advertising-bill data. The broadcasting satellite 111 receives the uplink radio signal. The broadcasting satellite 111 generates a downlink radio signal in response to the received uplink radio signal. The generated downlink radio signal contains the advertising-bill data. The broadcasting satellite 111 transmits the downlink radio signal toward the STB's 116.

The broadcasting station 113 is designed for transmitting television programs and an electronic program guide (EPG). The EPG has a list of the dates, channels, and time lengths of the broadcasting of television programs. The broadcasting station 113 transmits an uplink radio signal toward the broadcasting satellite 111 which represents a television program and an EPG. The broadcasting satellite 111 receives the uplink radio signal. The broadcasting satellite 111 generates a downlink radio signal in response to the received uplink radio signal. The generated downlink radio signal represents the television program and the EPG. The broadcasting satellite 111 transmits the downlink radio signal toward the STB's 116. Accordingly, the television program and the EPG are broadcasted together.

With reference to FIG. 14, an STB 116 is connected with a television apparatus 117 and a portable terminal device 119. The portable terminal device 119 includes, for example, a portable game machine. A VTR (video tape recorder) 118 is connected with the television apparatus 117. The STB 116 receives a downlink radio signal from the broadcasting satellite 111. The STB 116 converts the received downlink radio signal into a normal television signal representative of a television program. The STB 116 outputs the television signal to the television apparatus 117 so that the television program represented by the television signal can be reproduced by the television apparatus 117. The television signal can be passed to the VTR 118 through the television apparatus 117. Thus, the television signal can be recorded by the VTR 118.

The STB 116 includes a demodulator for extracting data from the received downlink radio signal. The STB 116 outputs the extracted data to the portable terminal device 119.

The broadcasting station 112 includes a formatting device or an encoding device for converting advertising-bill data into a stream of packets. The broadcasting station 112 further includes a modulator for converting the stream of packets into an uplink radio signal. Similarly, the broadcasting station 113 includes a formatting device or an encoding device for converting a signal of a television program and a signal of an EPG into a stream of packets. The broadcasting station 113 further includes a modulator for converting the stream of packets into an uplink radio signal.

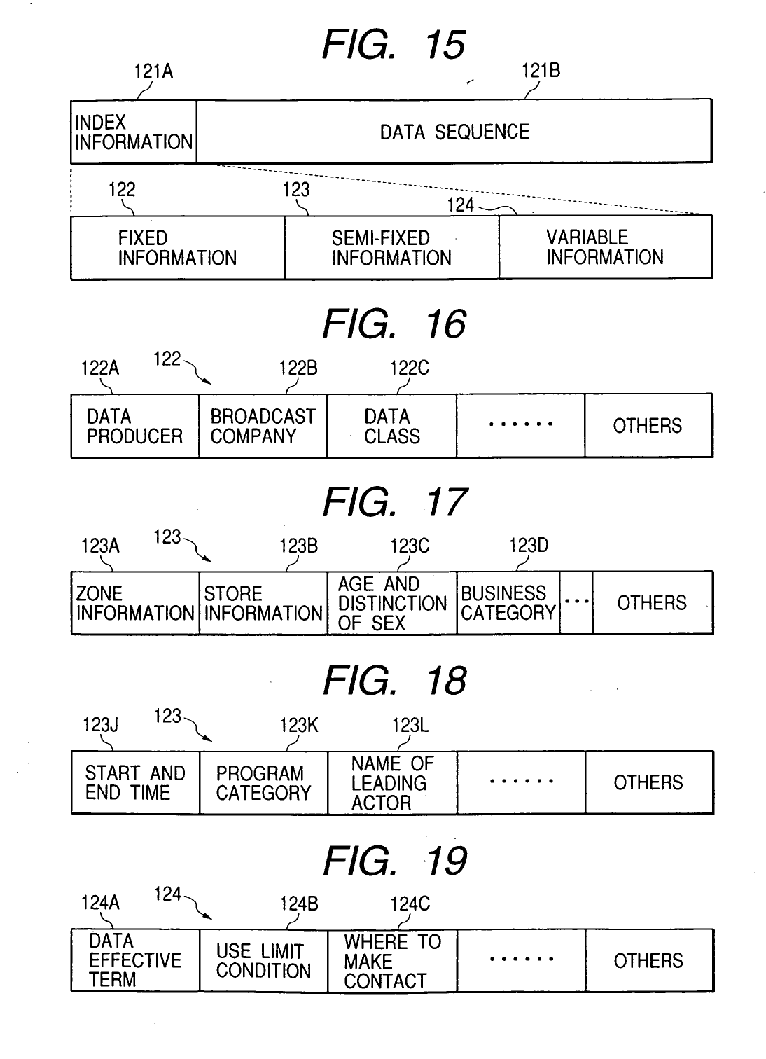

Each of uplink radio signals transmitted from the broadcasting stations 112 and 113 includes a stream of packets. As shown in FIG. 15, every packet has index information 121A and a data sequence 121B. In the packet, the index information 121A is followed by the data sequence 121B. The data sequence 121B represents at least a portion of contents such as a television program, an electronic advertising bill, or an EPG. The index information 121A relates to data in the sequence 121B. In more detail, the index information 121A relates to contents of a television program, an electronic advertising bill, or an EPG whose portion is in the data sequence 121B. The index information 121A and the data in the sequence 121B occupy different fields in the packet, respectively. As shown in FIG. 15, the index information 121A has a set of fixed information 122, semi-fixed information 123, and variable information 124 which are arranged in that order.

As shown in FIG. 16, the fixed information 122 has a set of pieces including pieces 122A, 122B, and 122C. The fixed information 122 is independent of the type of data in the related sequence 121B. The information piece 122A indicates a producer or a copyright holder of data in the sequence 121B. The information piece 122B indicates a broadcasting company. The information piece 122C indicates the class of data in the sequence 121B. The class of data includes the type of a character code used by data in the sequence 121B.

As shown in FIG. 17, the semi-fixed information 123 for an electronic advertising bill has a set of pieces including pieces 123A, 123B, 123C, and 123D. The information piece 123A is zone information for limiting effective zones. The information piece 123B is store information. The information piece 123C indicates an age and the distinction of sex. The information piece 123D indicates a category of business.

As shown in FIG. 18, the semi-fixed information 123 for an EPG has a set of pieces including pieces 123J, 123K, and 123L. The information piece 123J indicates the start time and end time of a television program. The information piece 123K indicates the category of the contents of a television program. The information piece 123L indicates the names of a leading actor, a director, and a scenario writer.

As shown in FIG. 19, the variable information 124 has a set of pieces including pieces 124A, 124B, and 124C. The information piece 124A indicates an effective term for data in the sequence 121B. The information piece 124B indicates a use limit condition such as a limit article number or an article purchase condition. The information piece 124C indicates where to make contact in an emergency.

The semi-fixed information 123 and the variable information 124 are classified according to human behavior responsive to an electronic advertising bill or a television news program. The classification is based on the address of a store putting articles on sale, the name of the store, the term of sale, the names of the articles, the prices of the articles, and the number of the articles. A suitable effective term, for example, less than one week, is set for a television news program.

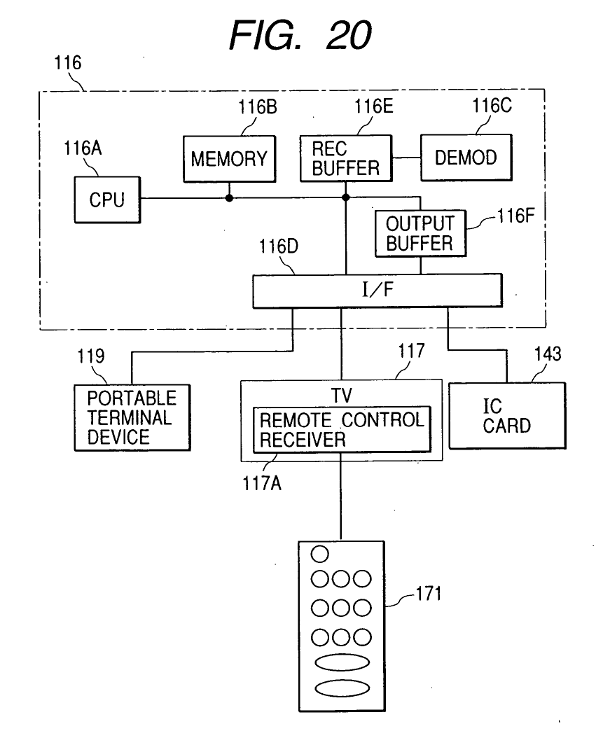

As shown in FIG. 20, the STB 116 includes a combination of a CPU 116A, a memory 116B, an interface 116D, a reception buffer (a reception memory) 116E, and an output buffer (an output memory) 116F. The STB 116 further includes a demodulator 116C connected with the reception buffer 116E. The CPU 116A operates in accordance with a control program stored in an internal ROM. According to the control program, the CPU 116A controls the memory 116B, the interface 116D, the reception buffer 116E, and the output buffer 116F to implement steps of operation which will be mentioned later. The interface 116D is connected with the television apparatus 117 and the portable terminal device 119. Thus, the CPU 116A can control the television apparatus 117 and the portable terminal device 119 via the interface 116D. A remote control transmitter 171 can communicate with a remote control receiver 117A provided in the television apparatus 117. The remote control transmitter 171 has buttons for inputting signals. Signals can be transmitted between the remote control transmitter 171 and the interface 116D in the STB 116 through the remote control receiver 117A in the television apparatus 117. An IC card 143 can be connected with the interface 116D in the STB 116.

Personal information is registered in the memory 116B within the STB 116 as follows. The CPU 116A controls the television apparatus 117 so that a display of the television apparatus 117 will indicate questions about personal information such as the date of user's birth, the distinction of sex, a commutation route, user's hobby, and user's address. The user actuates the buttons on the remote control transmitter 171, thereby answering the questions. Signals representative of answers to the questions are sent from the remote control transmitter 171 to the interface 116D in the STB 116 through the remote control receiver 117A in the television apparatus 117. The CPU 116A operates to transfer the signals of the answers to the questions from the interface 116D to the memory 116B. The signals of the answers to the questions compose personal information. In this way, the personal information is stored in the memory 116B.

Alternatively, personal information may be registered in the memory 116B within the STB 116 in a way as follows. A suitable data writer stores personal information into the IC card 143. The IC card 143 includes a semiconductor memory. The personal information indicates the date of user's birth, the distinction of sex, a commutation route, user's hobby, and user's address. The IC card 143 is connected with the interface 116D in the STB 116. The CPU 116A in the STB 116 operates to transfer the personal information from the IC card 143 to the memory 116B within the STB 116 via the interface 116D. Thus, the personal information is stored in the memory 116B.

It should be noted that personal information may be registered in the memory 116B within the STB 116 in a voice-based inputting way or another way different from the above-mentioned ways.

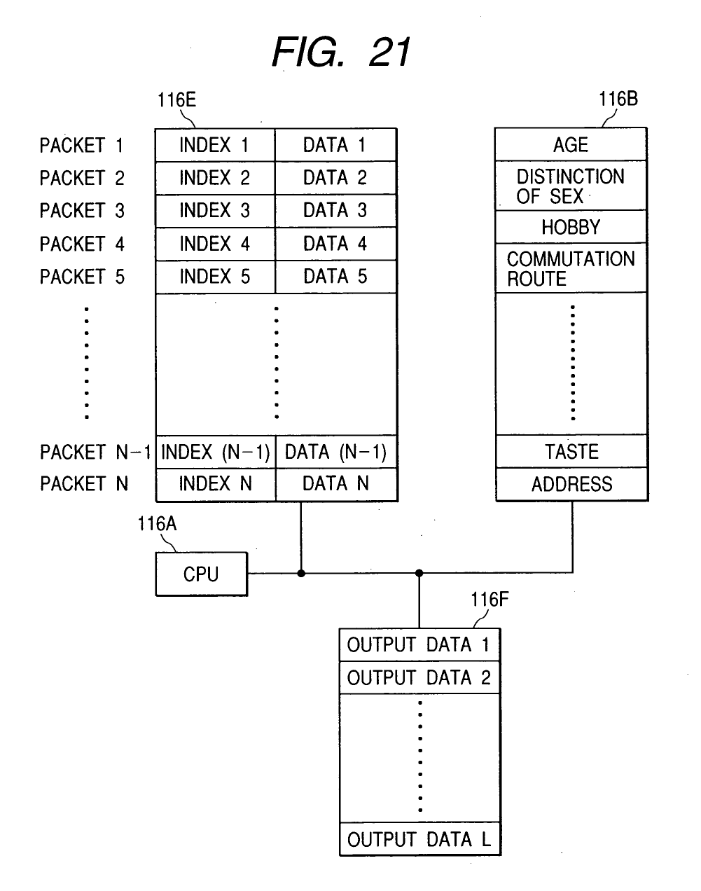

In the STB 116, the demodulator 116C recovers a stream of packets. from a received downlink radio signal. The demodulator 116C sequentially stores the packets into the reception buffer 116E. Thus, as shown in FIG. 21, packets “1”, “2”, . . . , “N−1”, and “N” each having a set of index information and a data sequence are stored in the reception buffer 116E. The CPU 116A reads the index information and the personal information from the reception buffer 116E and the memory 116B. The CPU 116A selects ones from the data sequences in the packets in the reception buffer 116E in response to the index information and the personal information. The CPU 116A operates to transfer the selected data sequences from the reception buffer 116E to the output buffer 116F. The CPU 116A controls the interface 116D to send the selected data sequences from the output buffer 116F to the television apparatus 117. The CPU 116A controls the television apparatus 117 via the interface 116D so that the display of the television apparatus 117 will indicate the contents of the selected data sequences. The CPU 116A may control the interface 116D to send the selected data sequences from the output buffer 116F to the portable terminal device 119. In this case, the CPU 116A controls the portable terminal device 119 via the interface 116D so that a display of the portable terminal device 119 will indicate the contents of the selected data sequences.

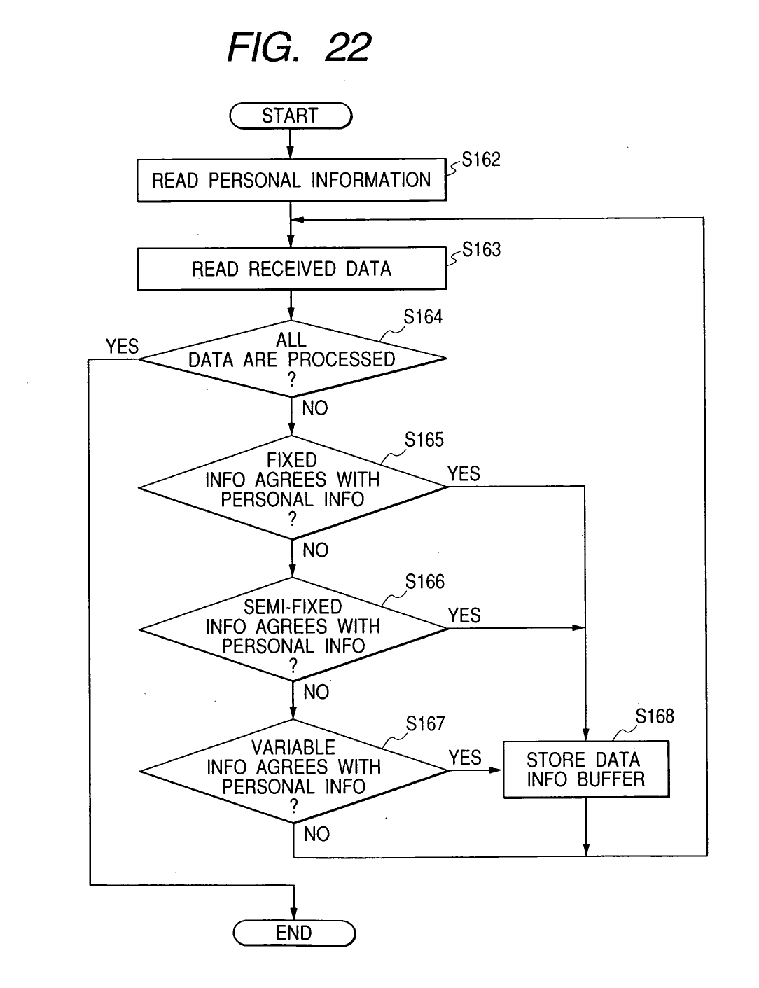

As previously mentioned, the CPU 116A in the STB 116 operates in accordance with a control program. FIG. 22 is a flowchart of a segment of the control program for the CPU 116A. The control-program segment in FIG. 22 is repetitively executed.

As shown in FIG. 22, a first step S162 of the control-program segment reads personal information from the memory 116B. After the step S162, the control program advances to a step S163.

The step S163 reads, from the reception buffer 116E, sets (packets) each having index information and a data sequence. The sets are referred to as the information/data sets.

A step S164 following the step S163 decides whether or not all the information/data sets have been processed. When all the information/data sets have been processed, the control program exits from the step S164 and then the current execution cycle of the control-program segment ends. Otherwise, the control program advances from the step S164 to a step S165.

The step S165 selects one from the unprocessed information/data sets according to predetermined order-decision rules. The step S165 extracts fixed information 122 from index information 121A in the selected information/data set. The step S165 decides whether or not the fixed information 122 agrees with a related portion of the personal information. When the fixed information 122 agrees with the related portion of the personal information, the control program advances from the step S165 to a step S168. Otherwise, the control program advances from the step S165 to a step S166.

The step S166 extracts semi-fixed information 123 from the index information 121A in the selected information/data set. The step S166 decides whether or not the semi-fixed information 123 agrees with a related portion of the personal information. When the semi-fixed information 123 agrees with the related portion of the personal information, the control program advances from the step S166 to the step S168. Otherwise, the control program advances from the step S166 to a step S167.

The step S167 extracts variable information 124 from the index information 121A in the selected information/data set. The step S167 decides whether or not the variable information 124 agrees with a related portion of the personal information. When the variable information 124 agrees with the related portion of the personal information, the control program advances from the step S167 to the step S168. Otherwise, the control program returns from the step S167 to the step S163.

The step S168 transfers the data sequence in the selected information/data set from the reception buffer 116E to the output buffer 116F. The step S168 may transfer the selected information/data set from the reception buffer 116E to the output buffer 116F. After the step S168, the control program returns to the step S163.

As understood from the above description, data sequences related to index information 121A completely disagreeing with the personal information are prevented from traveling from the reception buffer 116E to the output buffer 116F.

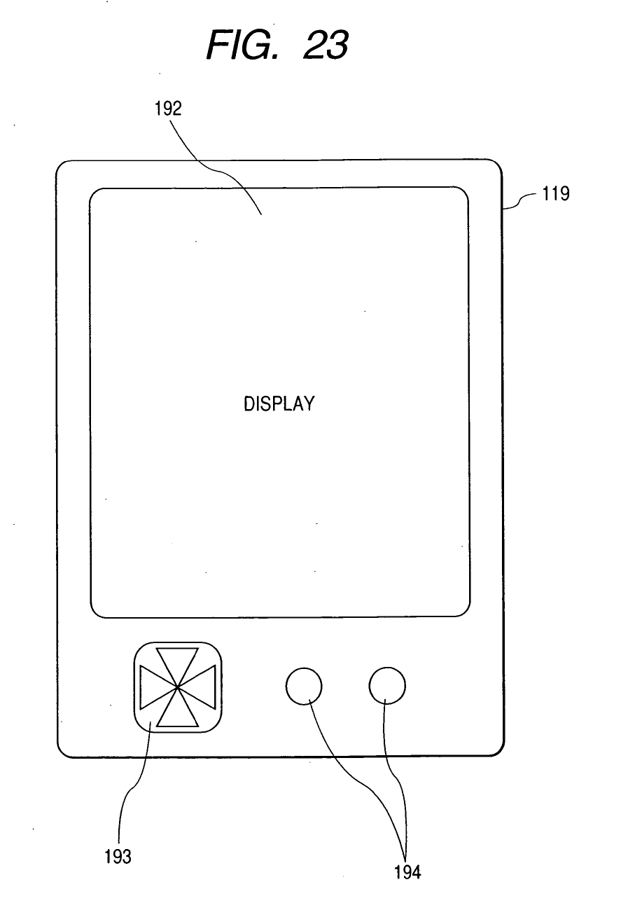

As shown in FIG. 23, the portable terminal device 119 has a display 192, keys 193, and buttons 194. The display 192 is of, for example, the liquid crystal type. The keys 193 are designed to point a portion of a picture indicated on the display 192. The buttons 194 are designed for deciding selected contents. The display 192 may be of the touch panel type. In this case, the keys 193 and the buttons 194 are omitted.

The portable terminal device 119 is connected with the STB 126. The connection between the portable terminal device 119 and the STB 126 is of the wire type, the wireless radio type, or the wireless infrared type. Signals and data can be transmitted between the portable terminal device 119 and the STB 126. For example, data representative of an EPG can be transmitted from the STB 126 to the portable terminal device 119. Learning data and control-command signals can be transmitted from the portable terminal device 119 to the STB 126.

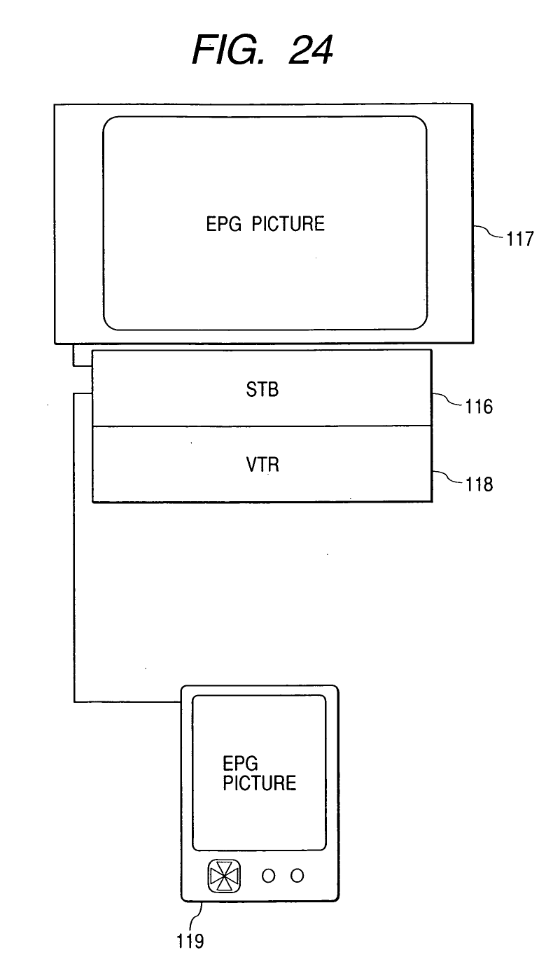

As shown in FIG. 24, EPG pictures can be indicated on the displays of the television apparatus 117 and the portable terminal device 119, respectively. While the EPG pictures are monitored, the reproduction of a desired television program by the television apparatus 117 and the recording of a desired television program by the VTR 118 can be reserved. Data related to the reservations can be saved.

The index information may be designed for enabling television programs to be selected from the EPG in response to the registered personal information. In this case, the selected television programs are reproduced by the television apparatus 117 or the portable terminal device 119. In other words, the selected television programs are indicated on the display of the television apparatus 117 or the portable terminal device 119.

It should be noted that the digital television broadcasting system of FIG. 14 may use terrestrial broadcasting instead of satellite broadcasting. Also, the digital television broadcasting system of FIG. 14 may use a combination of satellite broadcasting and cable television.

Fourth Embodiment

A fourth embodiment of this invention is similar to the third embodiment thereof except for design changes mentioned later. In the fourth embodiment of this invention, every packet in uplink radio signals transmitted from the broadcasting stations 112 and 113 lacks index information 121A and has only a data sequence 121B.

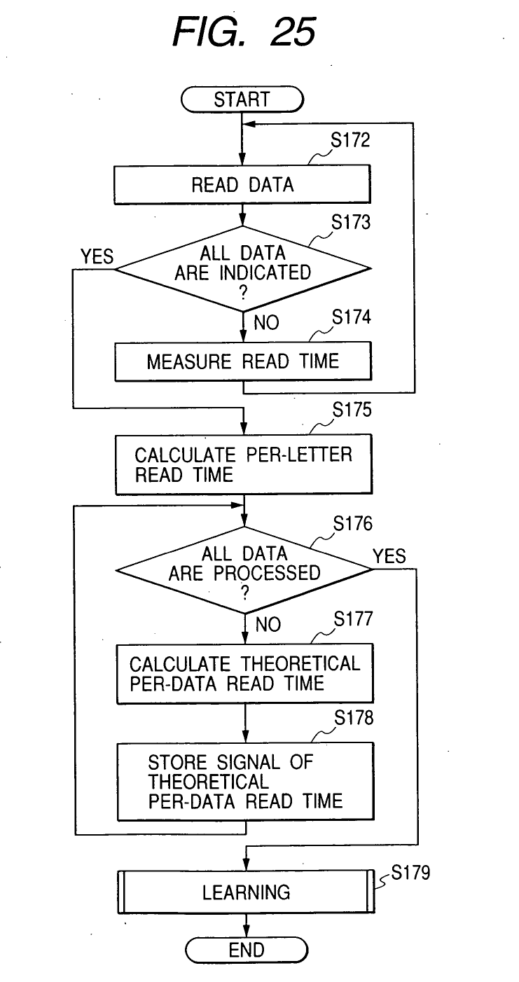

FIG. 25 is a flowchart of a segment of a control program for the CPU 116A in the fourth embodiment of this invention. The control-program segment in FIG. 25 is repetitively executed.

As shown in FIG. 25, a first step S172 of the control-program segment reads data sequences (in received packets) from the reception buffer 116E.

A step S173 following the step S172 decides whether or not all the data sequences have been indicated on at least one of the displays of the television apparatus 117 and the portable terminal device 119. When all the data sequences have been indicated, the control program advances from the step S173 to a step S175. Otherwise, the control program advances from the step S173 to a step S174.

The step S174 measures the time interval which the user takes to read the contents of currently indicated one of the data sequences. The step S174 stores a signal representative of the measured read time interval (the actual read time interval) into the memory 116B. After the step S174, the control program returns to the step S172.

The step S175 refers to the read time intervals measured by the step S174, and thereby calculates a mean time interval which the user takes to read one letter in the indicated contents of the data sequences. After the step S175, the control program advances to a step S176.

The step S176 decides whether or not all the data sequences have been processed. When all the data sequences have been processed, the control program advances from the step S176 to a block S179. Otherwise, the control program advances from the step S176 to a step S177.

The step S177 selects one from the unprocessed data sequences according to predetermined order-decision rules. The step S177 calculates a theoretical time interval which the user takes to read the indicated contents of the selected unprocessed data sequence on the basis of the 1-letter read time interval given by the step S175.

A step S178 following the step S177 stores a signal representative of the theoretical read time interval calculated by the step S177 into the memory 116B. After the step S178, the control program returns to the step S176.

The block S179 implements learning. After the block S179, the current execution cycle of the control-program segment ends.

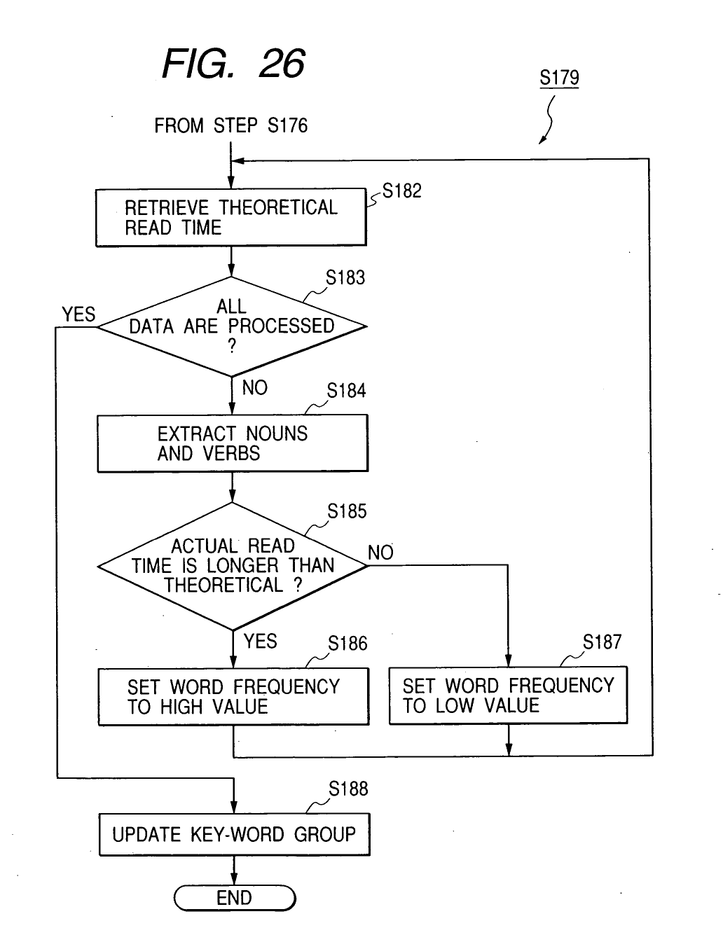

As shown in FIG. 26, the block S179 has steps S182, S183, S184, S185, S186, S187, and S188. The step S182 follows the step S176. The step S182 reads the signals of the theoretical read time intervals from the memory 116B.

The step S183 follows the step S182. The step S183 decides whether or not all the data sequences have been processed. When all the data sequences have been processed, the control program advances from the step S183 to the step S188. Otherwise, the control program advances from the step S183 to the step S184.

The step S184 selects one from the unprocessed data sequences according to predetermined order-decision rules. The step S184 collates the contents of the selected unprocessed data sequence with a dictionary represented by a signal stored in the ROM within the CPU 116A. By the collation, the step S184 extracts nouns and verbs from the contents of the selected unprocessed data sequence.

The step S185 follows the step S184. The step S185 retrieves the signal of the actual read time interval for the selected unprocessed data sequence from the memory 116B. In addition, the step S185 retrieves the signal of the theoretical read time interval for the selected unprocessed data sequence from the memory 116B. The step S185 compares the actual read time interval and the theoretical read time interval with each other. When the actual read time interval is longer than the theoretical read time interval, the control program advances from the step S185 to the step S186. Otherwise, the control program advances from the step S185 to the step S187.

The step S186 sets an effective frequency in use of the extracted nouns and verbs to a predetermined high value. After the step S186, the program returns to the step S182.

The step S187 sets an effective frequency in use of the extracted nouns and verbs to a predetermined low value. After the step S187, the program returns to the step S182.

The step S188 updates information representative of a group of key words. Specifically, the step S188 adds, to the key-word group, the nouns and verbs having the high effective frequency. The step S188 deletes, from the key-word group, the nouns and verbs having the low effective frequency. The step S188 stores information representative of the resultant key-word group into the memory 116B. After the step S188, the current execution cycle of the control-program segment ends.

The key-word-group information in the memory 116B is used instead of the personal information. Specifically, the CPU 116A searches the contents of all the data sequences in the reception buffer 116E for the key words represented by the key-word-group information. By referring to the results of the search, the CPU 116A decides whether or not the contents of each of the data sequences have at least one of the key words. The CPU 116A selects ones from the data sequences in the reception buffer 116E which have at least one of the key words. The CPU 116A operates to transfer only the selected data sequences from the reception buffer 116E to the output buffer 116F. As a result, only the contents of the selected data sequences are indicated on at least one of the displays of the television apparatus 117 and the portable terminal device 119.

Fifth Embodiment

A fifth embodiment of this invention is similar to the fourth embodiment thereof except for design changes mentioned later. In the fifth embodiment of this invention, data sequences are downloaded from the STB 116 into a memory within the portable terminal device 119. The contents of the downloaded data sequences are indicated on the display of the portable terminal device 119. A CPU in the portable terminal device 119 processes the downloaded data sequences. Operation of the CPU in the portable terminal device 119 is similar to operation of the CPU 116A in the STB 116 in the fourth embodiment of this invention. Accordingly, the CPU in the portable terminal device 119 measures the time interval which the user takes to read the contents of currently indicated one of the data sequences.

Sixth Embodiment

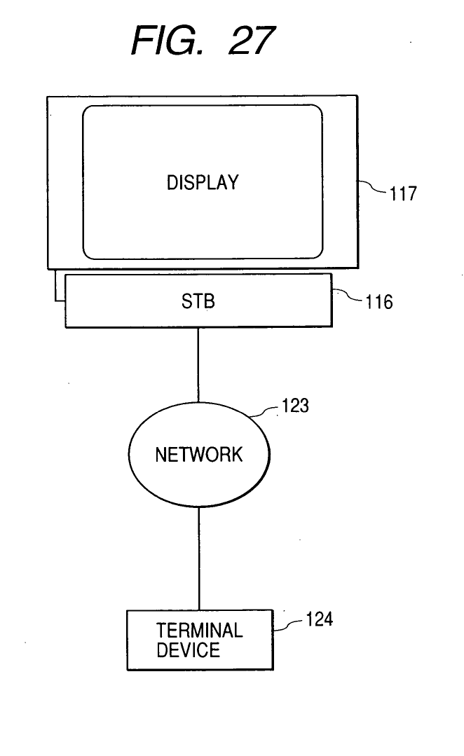

FIG. 27 shows a sixth embodiment of this invention which is similar to one of the third, fourth, and fifth embodiments thereof except for design changes mentioned later. According to the sixth embodiment of this invention, at least one is selected from electronic advertising bills represented by data sequences in received packets in response to the registered personal information. The selected electronic advertising bill is indicated on the display of the television apparatus 117 (or the portable terminal device 119).

As shown in FIG. 27, the STB 116 is connected with a network 123 such as a telephone network or the Internet. The STB 116 can communicate, over the network 123, with a terminal device 124 in a store or a settlement agency. The user decides a desired article while monitoring the electronic advertising bill indicated on the display of the television apparatus 117. The STB 116 communicates with the terminal device 124 to implement a settlement about the desired article. During the communication, an encrypted version of personal information representing an identification number of user's credit card, user's address, and user's telephone number is transmitted from the STB 116 to the terminal device 124 through the network 123.

Seventh Embodiment

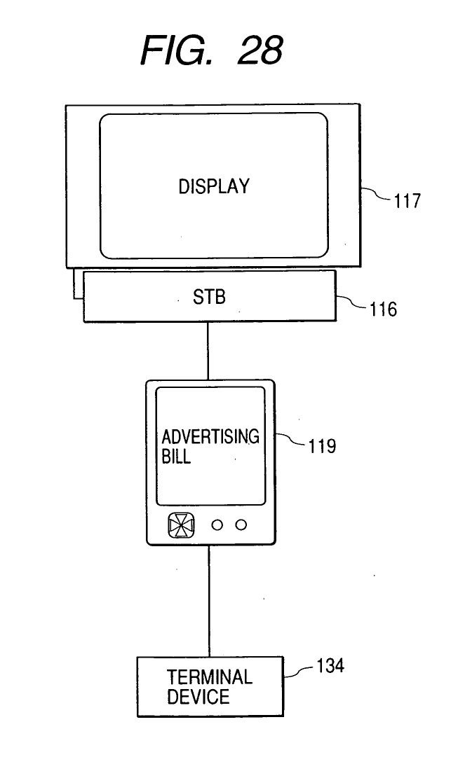

FIG. 28 shows a seventh embodiment of this invention which is similar to the sixth embodiment thereof except for design changes mentioned later. In the seventh embodiment of this invention, the portable terminal device 119 is connected with the STB 116. At least one is selected from electronic advertising bills represented by data sequences in received packets in response to the registered personal information. The data sequence representing the selected electronic advertising bill is downloaded from the STB 116 into the portable terminal device 119. The selected electronic advertising bill is indicated on the display of the portable terminal device 119.

The user can decide a desired article while monitoring the electronic advertising bill indicated on the display of the portable terminal device 119. The user disconnects the portable terminal device 119 from the STB 116. Then, the user can carry the portable terminal device 119 to a store. The desired article is indicated on the display of the portable terminal device 119. Thus, the user can inform a store person of the desired article by means of the portable terminal device 119.

The portable terminal device 119 can be connected with an in-store terminal device 134. Information representing the desired article can be fed from the portable terminal device 119 to the in-store terminal device 134. In this case, the in-store terminal device 134 outputs information which enables a store person to easily search a warehouse for the desired article.

The electronic advertising bill indicated on the display of the portable terminal device 119 may have an electronic coupon. The user can use the electronic coupon while informing a store person of the electronic coupon by means of the portable terminal device 119.

Information representing the electronic coupon can be fed from the portable terminal device 119 to the in-store terminal device 134, and thereby the user can use the electronic coupon.

The electronic advertising bill indicated on the display of the portable terminal device 119 may contain a store-chain advertising bill having an updatable use point card.

Electronic advertising bills represented by data sequences in received packets may be designed for travels. In this case, one is selected from travel advertising bills represented by data sequences in received packets in response to information representing the date on which the user will travel, and information representing a zone in which the user will travel. The data sequence representing the selected travel advertising bill is downloaded from the STB 116 into the portable terminal device 119. The selected travel advertising bill is indicated on the display of the portable terminal device 119.

The user disconnects the portable terminal device 119 from the STB 116. Then, the user connects the portable terminal device 119 with a terminal device 134 in a car navigation system. In this case, the data sequence representing the selected travel advertising bill is transmitted from the portable terminal device 119 to the terminal device 134. The location of the zone related to the selected travel advertising bill is indicated by the terminal device 134.

The travel advertising bill indicated on the display of the portable terminal device 119 may have an electronic hotel coupon. During the travel, the user carries the portable terminal device 119 to a hotel. The user can use the electronic hotel coupon while informing a hotel person of the electronic hotel coupon by means of the portable terminal device 119. Information representing the electronic hotel coupon can be fed from the portable terminal device 119 to a terminal device 134 in the hotel, and thereby the user can use the electronic hotel coupon.

What is claimed is:

1. A game-program distribution system comprising:
a broadcasting station for transmitting a signal containing first data representative of a television program and second data representative of a game program related to the television program;
a receiver for receiving the signal transmitted from the broadcasting station, and demodulating the received signal into the first data representative of the television program and the second data representative of the game program;
a game machine; and
means for downloading the second data representative of the game program from the receiver into the game machine.

2. A game-program distribution system as recited in claim 1, wherein the television program comprises an animation television program, and the game program relates to one of (1) a character in the animation television program and (2) a scenario of the animation television program.

3. A game-program distribution system as recited in claim 1, wherein the broadcasting station adds game-program rewriting information to the transmitted signal, and the receiver recovers the game-program rewriting information from the received signal, and the downloading means downloads the game-program rewriting information from the receiver into the game machine.

4. A game-program distribution system as recited in claim 1, wherein the broadcasting station adds accounting information to the transmitted signal, and the receiver recovers the accounting information from the received signal, and further comprising means for controlling use of the downloaded game program by the game machine in response to the accounting information recovered by the receiver.

5. A game-program distribution system as recited in claim 1, wherein the broadcasting station adds effective-term information to the transmitted signal, and the receiver recovers the effective-term information from the received signal, and further comprising means for permitting the game machine to use the downloaded game program in a term determined by the effective-term information.

6. A transmitting apparatus in the broadcasting station of claim 1.

7. A receiving apparatus comprising the receiver of claim 1.

8. A game machine comprising the game machine of claim 1.

9. A digital television broadcasting system comprising:
a broadcasting station for transmitting a signal containing (1) data pieces and (2) index information;
a receiver for receiving the signal transmitted from the broadcasting station, and demodulating the received signal into the data pieces and the index information;
first means provided in the receiver for selecting ones from the data pieces in response to the index information and personal information; and
second means for indicating the data pieces selected by the first means.

10. A digital television broadcasting system comprising:
a broadcasting station for transmitting a signal containing data and index information, the data representing an electronic program guide;
a receiver for receiving the signal transmitted from the broadcasting station, and demodulating the received signal into the data and the index information;
first means provided in the receiver for selecting television programs from the electronic program guide represented by the data in response to the index information and personal information; and
second means for indicating the television programs selected by the first means.

11. A digital television broadcasting system comprising:
a broadcasting station for transmitting a signal containing data and index information, the data representing electronic advertising bills;
a receiver for receiving the signal transmitted from the broadcasting station, and demodulating the received signal into the data and the index information;
first means provided in the receiver for selecting at least one from the electronic advertising bills represented by the data in response to the index information and personal information; and
second means for indicating the electronic advertising bill selected by the first means.

12. A digital television broadcasting system as recited in claim 9, wherein the index information comprises (1) fixed information independent of contents of the data pieces and (2) non-fixed information depending on the contents of the data pieces.

13. A digital television broadcasting system as recited in claim 9, further comprising a portable data terminal device, third means for downloading the selected data pieces from the receiver into the portable data terminal device, and fourth means provided in the portable data terminal device for indicating the downloaded data pieces.

14. A digital television broadcasting system as recited in claim 13, further comprising an in-store terminal device, and fifth means for transmitting the downloaded data pieces from the portable terminal device to the in-store terminal device.

15. A transmitting apparatus in the broadcasting station of claim 9.

16. A receiving apparatus comprising the receiver of claim 9.

17. A digital television broadcasting system comprising:
a broadcasting station for transmitting a signal containing data pieces;
a receiver for receiving the signal transmitted from the broadcasting station, and demodulating the received signal into the data pieces;
first means provided in the receiver for selecting ones from the data pieces in response to key words; and
second means for indicating the data pieces selected by the first means.

18. A portable data terminal device comprising the portable data terminal device of claim 13.

19. An in-store terminal device comprising the in-store terminal device of claim 14.
